(19) United States
(12) Patent Application Publication
(10) Pub. No.: US 2025/0111414 A1
(43) Pub. Date: Apr. 3, 2025

(54) APPARATUS AND METHOD FOR AUTOMATED USER INTERACTIONS UTILIZING AN ARTIFICIAL INTELLIGENCE MODEL TRAINED ON A LARGE LANGUAGE MODEL PROMPTED WITH COMPANY DATA AND SALES GUIDELINES

(71) Applicant: Incode Technologies, Inc., San Francisco, CA (US)

(72) Inventors: Ricardo AMPER, San Francisco, CA (US); Mark PETERS, San Francisco, CA (US); Jovan JOVANOVIC, Belgrade (RS); William De La CRUZ, San Francisco, CA (US); Natasa PRCETIC, San Francisco, CA (US); Miguel Angel VILLA, San Francisco, CA (US)

(21) Appl. No.: 18/898,051

(22) Filed: Sep. 26, 2024

Related U.S. Application Data
(60) Provisional application No. 63/586,246, filed on Sep. 28, 2023.

(51) Int. Cl. G06Q 30/02

(52) U.S. Cl. CPC G06Q 30/0281

(57) ABSTRACT

A computer-implemented method includes supplying a large language model with company data. The large language model is supplied with sales guidelines. A trained model is derived from the large language model. The trained model is utilized for automated user interactions.

### CROSS-REFERENCE TO RELATED APPLICATION

This application claims priority to U.S. Provisional Patent Application 63/586,246, filed Sep. 28, 2024, the contents of which are incorporated herein by reference.

### FIELD OF THE INVENTION

This application relates generally to computer network communications. More particularly, this application is directed to techniques for automated user interactions utilizing an artificial intelligence model trained on a large language model prompted with company data and sales guidelines.

### BACKGROUND OF THE INVENTION

Vendors of goods and services are attempting to automate computer network interactions with users (customers). More particularly, there are ongoing efforts to automate customer onboarding and sales operations.

Unfortunately, lengthy and complicated onboarding processes can lead to customer frustration and drop-off. Traditional sales tools often offer a generic experience that fails to connect with diverse customer needs and preferences.

Thus, there is a need for improved automated user interactions in computer networks.

### SUMMARY OF THE INVENTION

A computer-implemented method includes supplying a large language model with company data. The large language model is supplied with sales guidelines. A trained model is derived from the large language model. The trained model is utilized for automated user interactions.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates a user interface for initiating customer interactions.

FIG. 4 illustrates a user interface with prompts for soliciting information from a customer.

FIG. 5 illustrates a user interface with prompts for soliciting additional information from a customer.

FIG. 6 illustrates a user interface with tailored information for a customer.

FIG. 7 illustrates a user interface with prompts for obtaining additional user information.

Like reference numerals refer to corresponding parts throughout the several views of the drawings.

### DETAILED DESCRIPTION OF THE INVENTION

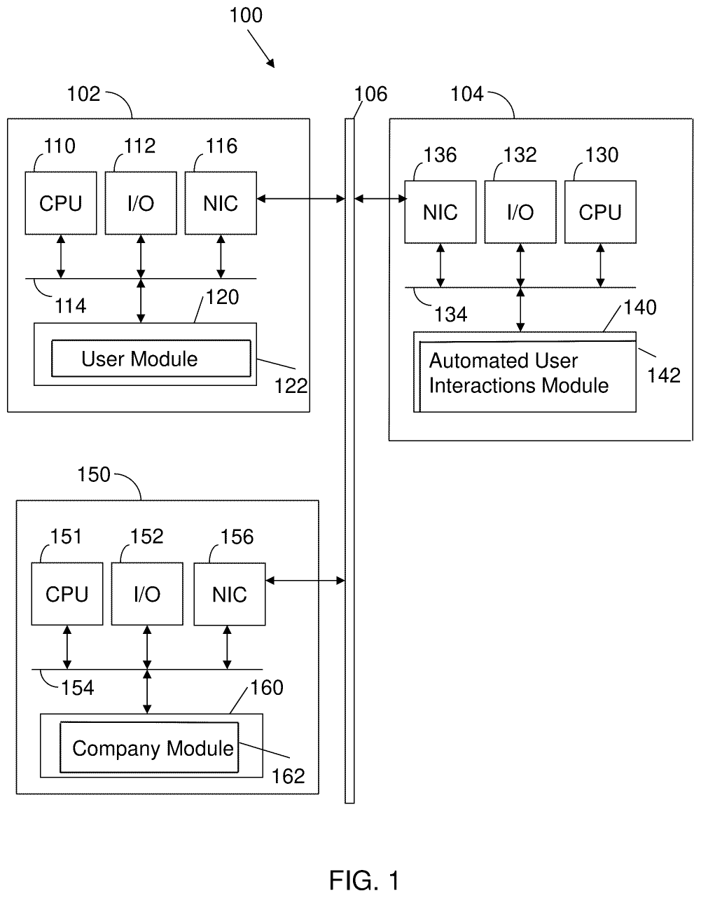

FIG. 1 illustrates a system 100 configured in accordance with an embodiment of the invention. A user machine 102 (also called a customer machine or a client machine) interacts with a server 104 via a network 106, which may be any combination of wired and wireless networks. A company machine 150 is also connected to network 106.

Client machine 102 includes a processor 110 connected to input/output devices 112 via a bus 114. The input/output devices 112 may include a keyboard, mouse, touch display and the like. A network interface circuit 116 is also connected to bus 114 to provide connectivity to network 106. A memory 120 is also connected to the bus 114. The memory 120 stores a user module 122 with instructions executed by processor 102 to interact with server 104.

Server 104 also includes a processor 130, input/output devices 132, a bus 134 and a network interface circuit 136. A memory 140 is connected to bus 134. The memory 140 stores an automated user interactions module 142 with instructions executed by processor 130 to implement operations disclosed herein. Those operations include interacting with user machine 102, as detailed below. Those operations also include interacting with company machine 150 to obtain information that informs the nature of the communications with the user machine 102.

Company machine 150 includes a processor 151, input/output devices 152, bus 154 and network interface circuit 156. A memory 160 is also connected to bus 154. The memory 160 stores a company module 162 with instructions executed by processor 151 to supply company data and sales guidelines to the automated user interactions module 142, as detailed below.

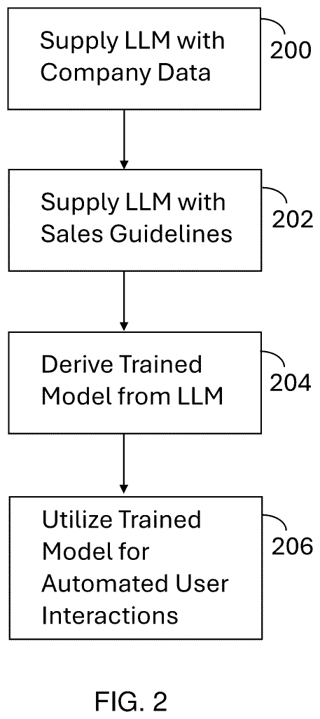

FIG. 2 illustrates processing operations implemented by the automated user interactions module 142. Initially, an artificial intelligence large language model (LLM) is supplied 200 with company data. The company data can include product or service details, company background information, company branding guidelines, preferences for known users, company offers, and the like.

Next, the LLM is supplied 202 with sales guidelines. The sales guidelines can include sales user interface best practice guidelines, known preferences for a known current user, user interface guidelines, proprietary artificial intelligence agent definitions, and the like. The supplied information is used to derive a trained model 204. The trained model utilizes a stage analysis agent and conversation generation agent, as discussed below.

The trained model is subsequently utilized for automated user interactions 206, examples of which are supplied below. Consider the case of a bank (e.g., Incobank Financial, a successful financial institution in Mexico) endeavoring to engage a networked customer in relation to different credit cards available. The networked customer operates user machine 102, while the bank operates server 104. Prior to the customer interaction, server 104 communicates with company machine 150 to obtain company background information. The information may include the fact that Incobank is one of the largest and most successful financial institutions in Mexico. The information may include company mission information, such as “Our mission is to provide access to the best credit cards to create more economic opportunity for customers.”

The company information also includes information about products and services available. The automated user interactions module 142 includes prompts supplied to the company machine 150 to obtain such information. The prompts solicit information on products, product requirements, product selling points and images associated with the products. This may result in the product options shown in Table 1.

TABLE 1
Product Options

1. Incobank For You: This is the best card for users who want cash back on their purchases
(https://incobank.me/ForYou.png). The Incobank For You card has an annual fee of $50 USD.
However, the annual fee will be waived for your first year if you spend more than $200
USD in the first 30 days after you receive the card. You will receive 1% cash back on all
purchases plus an additional 1% cash back on gasoline purchases during the week and
restaurant purchases during the weekend. There is no interest for 6 months on purchases
made in your first 30 days. For your first twelve months, you will be charged a monthly
interest rate of 2.25%. To be eligible for this card, you must be between 18 and 65 years
old. You must have a monthly income of $350 USD. You also must have a credit history
with another credit card. Maximum spending limit on card is $2,000 USD per month.
2. Incobank Classic: This card is a good option for those who want a basic credit card with
a low annual fee (https://incobank.me/Classic.png). It offers a rewards program and travel
assistance services, but with fewer perks than the Platinum card. The Incobank Classic card
has an annual fee of $33 USD. However, the annual fee will be waived for your first year if
you spend more than $200 in the first 30 days after you receive this card. You will receive
2 points in Incobank Total Rewards for every $1 USD that you spend. Incobank Total
Rewards can be spent on airline tickets, hotel nights or vacation packages. There is no
interest for 6 months on purchases made in your first 30 days. For your first twelve months,
you will be charged a monthly interest rate of 2.08%. To be eligible for this card, you must
be between 18 and 65 years old. You must have a monthly income of $350 USD. You also
must have a credit history with another credit card. Maximum spending limit on card
is $2,000 USD per month.
3. Incobank Gold: This card offers a higher credit limit than the Classic card and a more
comprehensive rewards program, with higher point earnings and more redemption options
(https://incobank.me/Gold.png). This is the image of the credit card. It also offers travel
insurance and other benefits. The Incobank Gold card has an annual fee of $50 USD.
However, the annual fee will be waived for your first year if you spend more than $200
USD in the first 30 days after you receive the card. You will receive 2.3 points in Incobank
Total Rewards for every $1 USD that you spend. Incobank Total Rewards can be spent on
airline tickets, hotel nights or vacation packages. There is no interest for 6 months on
purchases made in your first 30 days. For your first twelve months, you will be charged a
monthly interest rate of 2.08%. To be eligible for this card, you must be between 18 and 65
years old. You must have a monthly income of $500 USD. You also must have a credit
history with another credit card. Maximum spending limit on card is $4,000 USD per month.

The company data may include preferences for known users. The information in Table 2 provides user information that can be used to personalize user interactions.

TABLE 2

| | |
|---|---|
| 1 | curl --location ‘https://call_location’ \ |
| 2 | --header ‘x-api-key: ZZZZZ’ \ |
| 3 | --header ’Content-Type: application/json’ \ |
| 4 | --data ‘{ |
| 5 | “phone”: “+525585543899”, |
| 6 | “context”: “Antonio is a 32-year-old resident of Guadalajara, Mexico. |
| 7 | He holds a stable job as a project manager in a local IT firm, |
| 8 | and he‘\’’s currently looking for a credit card to expand his |
| 9 | purchasing power and manage unexpected expenses more effectively.”, |
| 10 | “retries_enabled”: true, |
| 11 | “full_name”: “Willian De la Cruz”, |
| 12 | “redirect_url”: “https://incobank.me/agent”, |
| 13 | “client_id”: “YYYYY” |
| 14 | }’ |

The company data can also include sales guidelines. Prompts are supplied by the automated user interactions module 142 to the company machine 150 to collect such information. The prompts may solicit information on branding guidelines, sales best practices guidelines, user interface guidelines, proprietary artificial intelligence agent definitions, and the like. Table 3 illustrates a conversation guide that may be supplied to an LLM.

TABLE 3
Conversation Guide

This is guide for the conversation with potential customer:
-Do not offer Incode ID as an option for signing up for a card. Collect all the information
in the chat.
-When presenting multiple or all cards to the customer display them as enumerated list
with a letter in front. For example:
A. Incobank Classic:
Image: https://incobank.me/Classic.png
Description: A basic credit card with a low annual fee and a rewards program. Offers travel
assistance services and earns 2 points in Incobank Total Rewards for every $1 spent.
B. Incobank Gold:
Image: https://incobank.me/Gold.png
Description: A card with a higher credit limit and a more comprehensive rewards program.
Earns 2.3 points in Incobank Total Rewards for every $1 spent and offers travel
insurance and other benefits.
-When presenting multiple cards to the customer and asking which card they would be
interested in, display the card options as an enumerated list. For example:
1. Incobank for You
2. Incobank AT&T Elite
-When you start the conversation, don't ask the customer if they have a minute to talk. Just
start the conversation. Introduce yourself, tell the users that you will help find them a great
credit card in less than 5 minutes and ask for their name. Don't add any extra sentences,
Don't describe your mission.
-Be concise. Keep your responses in short length to retain the user's attention.

The foregoing company data is supplied to an LLM, which corresponds to operation 200 of FIG. 2. Operation 202 of FIG. 2 is to supply sales guidelines to the LLM. Table 4 is an example of sales guidelines and best practices that can coordinate conversation stages to a goal. The information in Table 4 is obtained from prompts supplied to the company machine 150 from the automated user interactions module 142.

TABLE 4

| | |
|---|---|
| 1 | Now determine what should be the next immediate conversation stage for the agent |
| 2 | in the sales conversation by selecting one from the |

following options: 3

| | |
|---|---|
| 4 | 1. Value proposition: Briefly explain the benefits of Incobank credit cards and |
| 5 | ask for the |

customer's name.

| | |
|---|---|
| 6 | |
| 7 | 2. Needs analysis and identify best options: Ask specific questions to understand |
| 8 | what features or perks the customer is most interested in and what type of card |
| 9 | they would meet the requirements for. Based on the prospect's needs, ask more |
| 10 | questions to find the best 1 to 2 cards for them. Keep asking questions until |
| 11 | you have narrowed the number of cards that meet their needs. During this process, |
| 12 | you will also be collecting key information that will start their |

application. 13

| | |
|---|---|
| 14 | 3. Solution presentation: Based on the prospect's needs, present the best one or |
| 15 | two credit card\| for the customer. Present two cards if there are two cards which |
| 16 | meet their criteria and one card is not clearly better than the other. Encourage |
| 17 | them to move forward with an application |

to one card. 18

| | |
|---|---|
| 19 | 4. Application: After the prospect has expressed interest in a specific card, |
| 20 | ask if they want to Apply with Incode ID or Apply in the Chat. The fastest way |
| 21 | to complete the application if the prospect already has an Incode ID is to |
| 22 | connect their Incode ID and share key information for the application. If they |
| 23 | choose this option, the application is done. If they don't have an Incode ID |
| 24 | or don't want to use it, then continue to collect the required information in |
| 25 | the chat. |

The information supplied to the LLM results in a trained model, which is shown as step 204 in FIG. 2. In an embodiment, the trained model utilizes a stage analysis agent and a conversation generation agent. The stage analysis agent is responsible for analyzing the current state of the conversation. It processes the conversation history and any additional contextual information to determine the appropriate stage or phase of the interaction. The conversation generation agent generates responses based on the output of the stage analysis agent. It produces content that is contextually appropriate for the identified conversation stage.

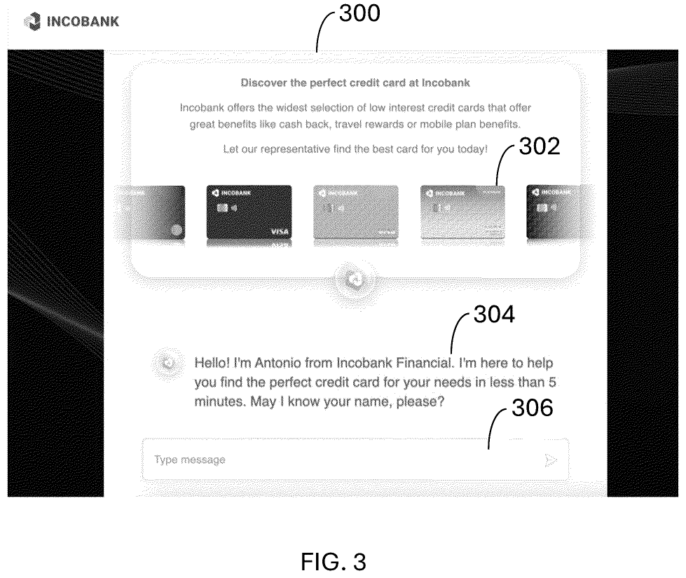

The final operation in FIG. 2 is to utilize the trained model for automated user interactions 206. The following discussion provides an example of such interactions. FIG. 3 illustrates a user interface 300 that may be used in accordance with an embodiment of the invention. The trained model within the automated user interactions module 142 supplies user interface 300 to initiate networked communication with client machine 102. Interface 300 includes product image 302, a prompt 304 to request information and a text input box 306 to collect the information.

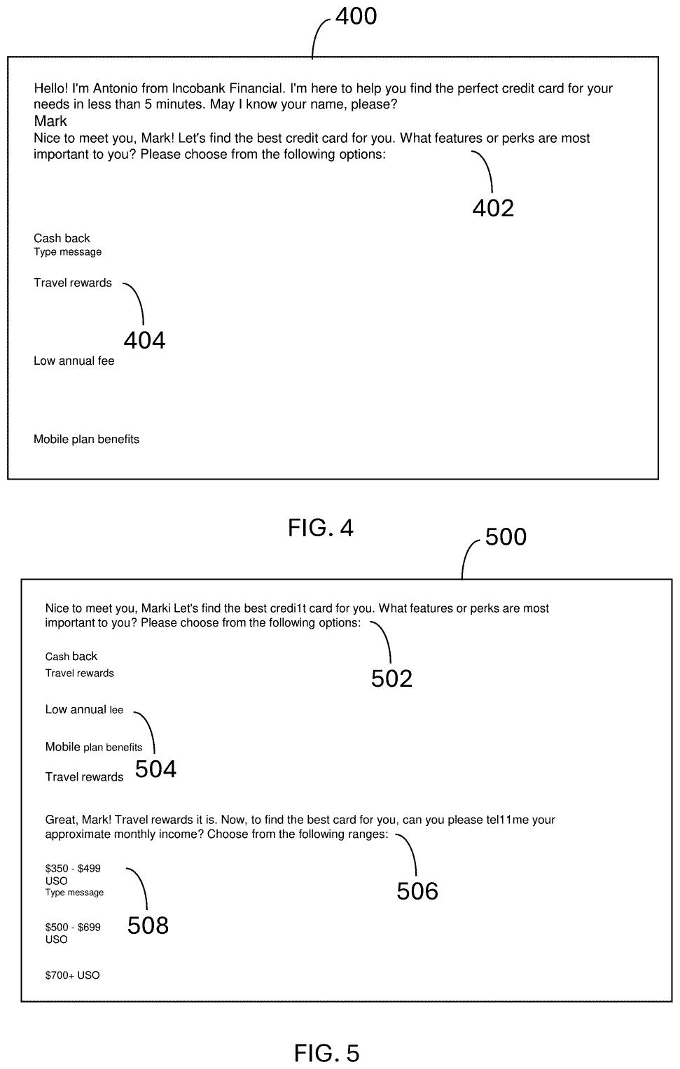

FIG. 4 illustrates an interface 400 with prompts to solicit more user information. Text 402 solicits information, while buttons 404 allow a user to specify feedback.

FIG. 5 illustrates a user interface 500 to solicit more user feedback. Text 502 asks for option selection, while buttons 504 allow option selection. Similarly, text 506 request user information, while buttons 508 collect user input.

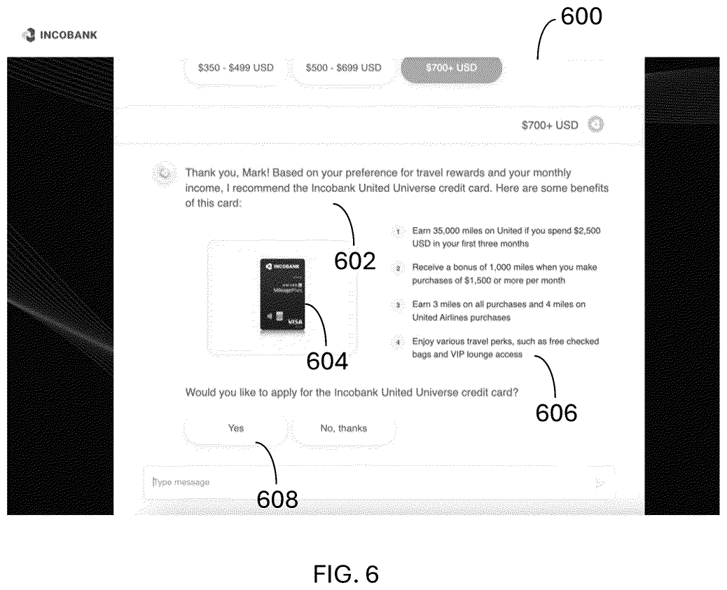

After the customer has provided enough information about their needs and ability to meet requirements, the trained model of the automated user interactions module will pitch the best product for that customer. FIG. 6 illustrates exemplary feedback in user interface 600. Text 602 includes a product recommendation. The product recommendation is accompanied by a product image 604 and bullet point features 606. Button 608 allows a user to accept the offer.

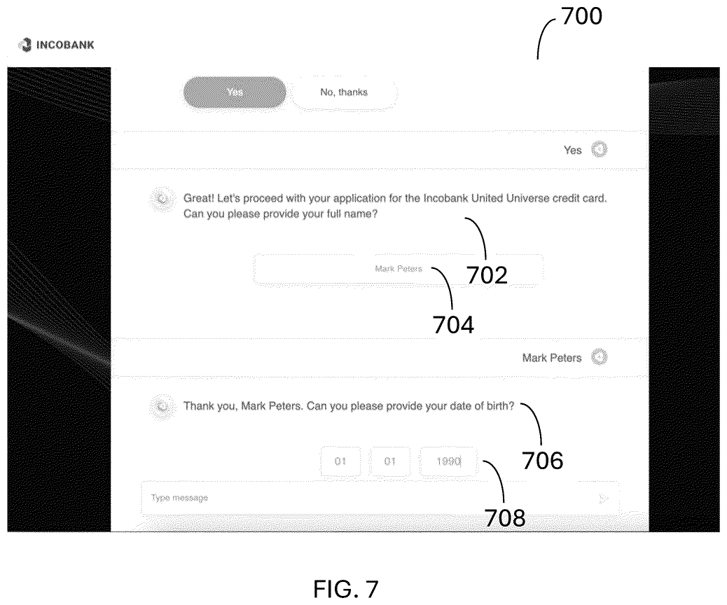

FIG. 7 illustrates an interface 700 that may be supplied by the automated user interactions module 142 if an offer is accepted. Interface 700 includes text 702 to solicit more user information and a text box 704 to input the information. The interface 700 also includes more text 706 to solicit more information and a text box 708 to collect the information.

Interface 700 is optional. An embodiment of the invention has the automated user interactions module 142 integrated with an identity verification platform. For example, automated user interactions module 142 can be integrated with Incode Omni®, Incode ID®, and/or Incode Verify® all sold by Incode Technologies, Inc., San Francisco, California. This results in an end-to-end sales discovery and user onboarding experience, which is consistent, personalized, and optimized. The invention's integration with Incode Omni® streamlines the identity verification process within the sales flow, allowing the system to guide customers through product discovery, selection, and a complete end-to-end onboarding experience. Incode Omni® provides the id verification steps to complete the sign-up process while meeting compliance requirements and combating fraud. The system can dynamically introduce onboarding steps (like phone capture or document collection) at the optimal time to maximize conversions while reducing fraud.

Incode ID® integration enables the automated user interactions module 142 to leverage instant verification capabilities. Users who have already created a verified identity with Incode IDR can simply agree to share verifications, thus expediting the onboarding process. This integration enables the system to provide an even more customized experience by utilizing light demographic data, such as age, gender, and postal code. Existing Incode ID® users are prompted to share this high-level demographic data early in the sales process to help create an even more personalized experience.

As previously indicated, the automated user interactions module 142 maintains a comprehensive record of the conversation history. This feature enables the agents to reference previously discussed information, ensuring continuity and relevance in the ongoing interaction.

The automated user interactions module 142 can generate responses in multiple formats, such as plain text as shown in the examples, but also structured data format (e.g., JSON). This flexibility allows for integration with various user interfaces and communication channels. Indeed, the module 142 is designed to operate across multiple communication platforms, including but not limited to: Web interfaces, as shown in the figures, Short Message Service (SMS), Messaging applications (e.g., WhatsApp) and Application Programming Interface (API) integration.

The Conversation Generation Agent creates responses that are: tailored to the current conversation stage, adaptable to user preferences and previous interactions, and capable of incorporating specific organizational data or guidelines. An embodiment of the invention has the capability to switch between different languages based on user input or predetermined settings.

An embodiment of the invention can be characterized as follows:

User input is received through one of the supported communication channels.

The Stage Analysis Agent processes the input along with the conversation history and any additional context.

The Stage Analysis Agent determines the current conversation stage and passes this information to the Conversation Generation Agent.

The Conversation Generation Agent creates an appropriate response based on the identified stage and any relevant contextual data.

The response is formatted according to the requirements of the chosen communication channel.

The formatted response is delivered to the user through the selected channel.

The entire interaction is logged and retained for future reference and analysis.

The disclosed system can be applied in various scenarios requiring structured, context-aware conversational interactions, such as: customer service automation, sales process optimization, lead qualification, information gathering, and dissemination. The dual-agent architecture, combined with context retention and multi-channel compatibility, provides a flexible framework for managing complex, multi-step conversational processes in an automated manner.

Those skilled in the art will recognize many advantages associated with the disclosed system. Many traditional Customer Relationship Management (CRM) tools offer features like lead tracking, customer management, and marketing automation. These systems often include a customer knowledge base for product and support information and might help to build web or application-based experiences to optimize sales. These solutions are limited in personalization, often require manual intervention, lack real-time AI-driven insights, and do not provide seamless identity verification integration.

Several chatbot platforms offer conversational experiences to guide customers through the sales process. Some chatbots are driven by AI. Most are not integrated into identity verification systems. These systems are typically rule-based, lack deep personalization, do not have a robust integration framework, and are not powered by advanced AI models.

Some e-commerce platforms have built-in recommendation engines to suggest products to customers. These products focus mainly on product recommendation without an integrated conversational experience, ID verification, or end-to-end onboarding. Many of these are not using AI.

An embodiment of the present invention relates to a computer storage product with a computer-readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media, optical media, magneto-optical media, and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer-implemented method, comprising:
supplying a large language model with company data;
supplying the large language model with sales guidelines;
deriving a trained model from the large language model; and
utilizing the trained model for automated user interactions.

2. The computer-implemented method of claim 1 wherein the company data includes product details.

3. The computer-implemented method of claim 1 wherein the company data includes company background information.

4. The computer-implemented method of claim 1 wherein the company data includes company branding guidelines.

5. The computer-implemented method of claim 1 wherein the company data includes preferences for known users.

6. The computer-implemented method of claim 1 wherein the company data includes company offers.

7. The computer-implemented method of claim 1 wherein the sales guidelines include sales best practice guidelines.

8. The computer-implemented method of claim 1 wherein the sales guidelines include instructions to use known preferences for a known current user.

9. The computer-implemented method of claim 1 wherein the sales guidelines include user interface sales best practice guidelines.

10. The computer-implemented method of claim 1 wherein the sales parameters include proprietary artificial intelligence agent definitions.

11. The computer-implemented method of claim 1 wherein the trained model dynamically derives current customer information.

12. The computer-implemented method of claim 1 wherein the trained model utilizes a stage analysis agent.

13. The computer-implemented method of claim 1 wherein the trained model utilizes a conversation generation agent.

14. The computer-implemented method of claim 1 further comprising integrating with an identity verification platform for automated identification of a user.
